(19) United States
(12) Patent Application Publication
(10) Pub. No.: US 2025/0111695 A1
(43) Pub. Date: Apr. 3, 2025

(54) Template-Based Behaviors in Machine Learning

(71) Applicant: Adobe Inc., San Jose, CA (US)

(72) Inventors: Wilmot Wei-Mau Li, Seattle, WA (US); Li-Yi Wei, Redwood City, CA (US); Cuong D. Nguyen, San Francisco, CA (US); Jakub Fiser, Milton Keynes (GB); Hijung Shin, Natick, MA (US); Stephen Joseph DiVerdi, Berkeley, CA (US); Seth John Walker, Oakland, CA (US); Kazi Rubaiat Habib, Bothell, WA (US); Deepali Aneja, Seattle, WA (US); David Gilliaert Werner, Pleasanton, CA (US); Erica K. Schisler, Spokane, WA (US)

(73) Assignee: Adobe Inc., San Jose, CA (US)

(21) Appl. No.: 18/543,234

(22) Filed: Dec. 18, 2023

Related U.S. Application Data
(60) Provisional application No. 63/586,165, filed on Sep. 28, 2023.

(51) Int. Cl. G06V 40/16; G06V 40/20

(52) U.S. Cl. CPC G06V 40/161; G06V 40/23

(57) ABSTRACT

In implementation of techniques for template-based behaviors in machine learning, a computing device implements a template system to receive a digital video and data executable to generate animated content. The template system determines a location within a frame of the digital video to place the animated content using a machine learning model. The template system then renders the animated content within the frame of the digital video at the location determined by the machine learning model. The template system then displays the rendered animated content within the frame of the digital video in a user interface.

### RELATED APPLICATION

This application claim priority under 35 U.S.C. § 119 (e) to U.S. Provisional Patent Application No. 63/586,165, filed Sep. 28, 2023, Attorney Docket No. P12493-US, and titled “TEMPLATE-BASED BEHAVIORS IN MACHINE LEARNING,” the entire disclosure of which is hereby incorporated by reference.

### BACKGROUND

In computer graphics, conventional digital video editing techniques involve manual manipulation of video footage, audio, and visual elements within editing software. Editors use a combination of techniques to craft a desired narrative and visual impression. Video clips are arranged on a timeline to create a cohesive sequence. Transitions, including cuts, fades, and dissolves, are timed to maintain the flow between shots. Color correction and grading are also performed to achieve a desired mood and consistency. Audio elements, including dialogue, music, and sound effects, are synchronized with the visuals to enhance storytelling.

These techniques involve artistic creativity, attention to detail, and a deep understanding of the software's capabilities, allowing editors to bring their vision to life and evoke emotions in the audience. However, manual techniques are time consuming and rely on user skill, which causes errors and results in visual inaccuracies, computational inefficiencies, and increased power consumption in real world scenarios.

### SUMMARY

Techniques and systems for template-based behaviors in machine learning are described. In an example, a template system receives a digital video and data executable to generate animated content. In some examples, the template system also receives an indication of a behavior including a specified movement for a portion of the animated content.

The template system determines a location within a frame of the digital video to place the animated content. In some examples, the machine learning model determines the location based on a location associated with an object detected in the frame of the digital video. For instance, rendering the animated content involves attaching a portion of the animated content to the object detected in the frame of the digital video. In other examples, the machine learning model determines the location based on tracking a pose of a detected person depicted in the frame of the digital video. Some examples include a portion of the animated content that is layered behind or in front of an object depicted in the frame of the digital video.

Based on the location, the template system renders the animated content within the frame of the digital video at the location determined by the machine learning model. The template system then displays the rendered animated content within the frame of the digital video in a user interface.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The detailed description is described with reference to the accompanying figures. Entities represented in the figures are indicative of one or more entities and thus reference is made interchangeably to single or plural forms of the entities in the discussion.

FIG. 1 is an illustration of a digital medium environment in an example implementation that is operable to employ techniques and systems for template-based behaviors in machine learning as described herein.

FIG. 2 depicts a system in an example implementation showing operation of a mesh progression module for template-based behaviors in machine learning.

FIG. 3 depicts an example of receiving an input including a template selection.

FIG. 4 depicts an example of receiving an input including a digital video.

FIG. 5 depicts an example of determining a location within a frame of the digital video to place animated content.

FIG. 6 depicts an example of determining the location based on a location of an object detected in the frame of the digital video and attaching a portion of the animated content to the object detected in the frame of the digital video.

FIG. 7 depicts an example of determining the location based on tracking a pose of a detected person depicted in the frame of the digital video.

FIG. 8 depicts an example of auto-framing a face depicted in the frame of the digital video.

FIG. 9 depicts an example of detecting audio of the digital video.

FIG. 10 depicts an example of rendering the animated content within the frame of the digital video at the location determined by the machine learning model.

FIG. 11 depicts a procedure in an example implementation of template-based behaviors in machine learning.

FIG. 12 depicts a procedure in an additional example implementation of template-based behaviors in machine learning.

FIG. 13 depicts a procedure in an additional example implementation of template-based behaviors in machine learning.

FIG. 14 illustrates an example system including various components of an example device that can be implemented as any type of computing device as described and/or utilized with reference to FIGS. 1-13 to implement embodiments of the techniques described herein.

### DETAILED DESCRIPTION

### Overview

Conventional digital video editing techniques involve manual manipulation of video footage using software tools. Editors are tasked with arranging clips on a timeline, cutting and trimming segments to achieve precise timing, and applying transitions, effects, and audio adjustments to enhance an overall visual and auditory experience. Text overlays, graphics, and visual effects are manually integrated into the digital video to provide context and visual interest. However, these conventional digital video editing techniques are time consuming and involve a deep understanding of the software's features and capabilities, as well as a knowledge of aesthetics. Incorporating text overlays, graphics, and visual effects into live videos is also difficult without obscuring salient portions of the live video because locations of the salient portions are unknown during live recording.

Techniques and systems are described for template-based behaviors in machine learning that overcome these limitations. A template system begins in this example by receiving a digital video and a template including data executable to generate animated content. The template specifies an arrangement of text, images, graphics, or other animated content for incorporation into the digital video. For example, the template specifies a text caption that is layered behind or in front of a detected person in the digital video. In some examples, the template also specifies a behavior including a specified movement for a portion of the animated content. For example, the template specifies a graphic depicting fireworks erupting around the detected person, without obscuring the detected person's face. The template is selected by the user from a group of pre-authored templates or is authored by the user for application to the digital video.

After receiving the digital video and the template, the template system then determines a location within a frame of the digital video to place the animated content that corresponds to the location specified in the template, using a machine learning model. The machine learning model is trained on multiple iterations of animated content incorporated into digital videos, as described in further detail below.

Based on the example above, the template specifies a text caption that is layered behind a detected person in the digital video. To determine a location in the frame of the digital video that satisfies the template, the machine learning model first detects a person in the frame of the digital video. Based on a location of the detected person, the machine learning model determines a location for the text that is layered behind the detected person but in front of a background of the digital video. In some examples, the machine learning model also considers legibility of the text and determines a location so that the text is readable behind the detected person while still satisfying instructions from the template.

In other examples, the template specifies a location in the digital video for attachment of a graphic. For example, the template specifies a star-shaped graphic attached to a detected person's face. In response, the machine learning model determines locations in frames of the digital video to place the star-shaped graphic using a facial detection model to identify faces in respective frames of the digital video. By doing so, the machine learning model creates an appearance that the animated content is attached to and moves with the detected person.

After determining the location within a frame of the digital video to place the animated content specified in the template, the template system renders the animated content within the frame of the digital video determined by the machine learning model. Some examples include determining a behavior of the animated content based on visual or audio content of the digital video. For example, the machine learning model determines a path for moving animated content that avoids obstructing a detected person's face, or the machine learning model choreographs timing of a behavior of animated content to synchronize with music or dialog. The template system then displays the rendered animated content within the frame of the digital video in a user interface.

Generating template-based behaviors in machine learning in this manner overcomes the disadvantages of conventional digital video editing techniques that are limited to manual integration of text overlays, graphics, and visual effects into digital video. For example, employing a machine learning model to determine a location to place animated content allows for automation of rendering and display of the animated content within the digital video. These techniques are also leveraged in real-time to apply template-based behaviors to live videos in some examples, which is not possible using conventional techniques or of being performed by a human being. For these reasons, generating template-based behaviors is faster and less prone to human error than conventional digital video editing techniques.

In the following discussion, an example environment is described that employs the techniques described herein. Example procedures are also described that are performable in the example environment as well as other environments. Consequently, performance of the example procedures is not limited to the example environment and the example environment is not limited to performance of the example procedures.

### Example Environment

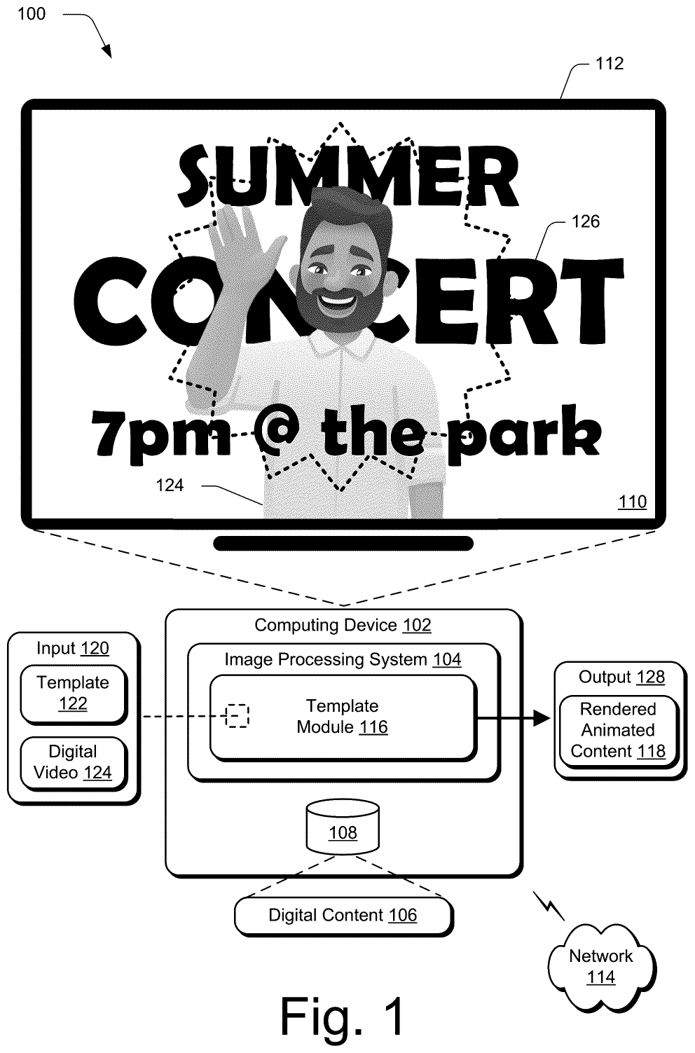

FIG. 1 is an illustration of a digital medium environment 100 in an example implementation that is operable to employ techniques and systems for template-based behaviors in machine learning described herein. The illustrated digital medium environment 100 includes a computing device 102, which is configurable in a variety of ways.

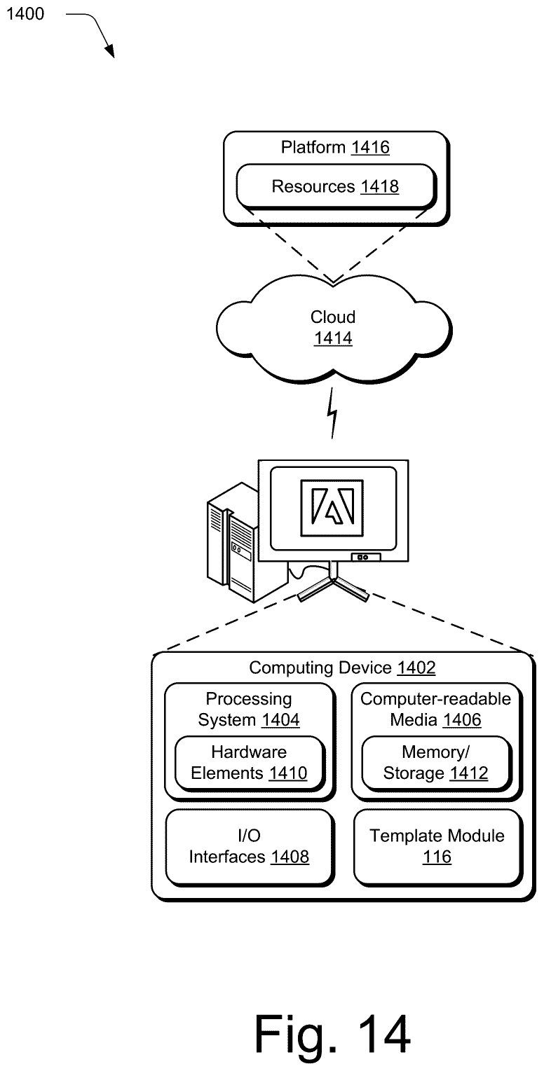

The computing device 102, for instance, is configurable as a desktop computer, a laptop computer, a mobile device (e.g., assuming a handheld configuration such as a tablet or mobile phone), an augmented reality device, and so forth. Thus, the computing device 102 ranges from full resource devices with substantial memory and processor resources (e.g., personal computers, game consoles) to a low-resource device with limited memory and/or processing resources, e.g., mobile devices. Additionally, although a single computing device 102 is shown, the computing device 102 is also representative of a plurality of different devices, such as multiple servers utilized by a business to perform operations “over the cloud” as described in FIG. 14.

The computing device 102 also includes an image processing system 104. The image processing system 104 is implemented at least partially in hardware of the computing device 102 to process and represent digital content 106, which is illustrated as maintained in storage 108 of the computing device 102. Such processing includes creation of the digital content 106, representation of the digital content 106, modification of the digital content 106, and rendering of the digital content 106 for display in a user interface 110 for output, e.g., by a display device 112. Although illustrated as implemented locally at the computing device 102, functionality of the image processing system 104 is also configurable entirely or partially via functionality available via the network 114, such as part of a web service or “in the cloud.”

The computing device 102 also includes a template module 116 which is illustrated as incorporated by the image processing system 104 to process the digital content 106. In some examples, the template module 116 is separate from the image processing system 104 such as in an example in which the template module 116 is available via the network 114.

The template module 116 is configured to generate rendered animated content 118. For example, the template module 116 first receives an input 120 including a template 122 and digital video 124. The template 122 includes data executable to generate animated content 126, including images, GIFs, videos, text, or other graphics for incorporation into the digital video 124. As illustrated, the template 122 includes layered text and a graphic. The data is executable to generate the animated content 126 that specifies two levels of text layered behind a detected person in the digital video 124 and one level of text layered in front of the detected person in the digital video 124. The data executable to generate the animated content 126 also specifies the graphic of an outline of a sun shape to overlay the detected person in the digital video 124.

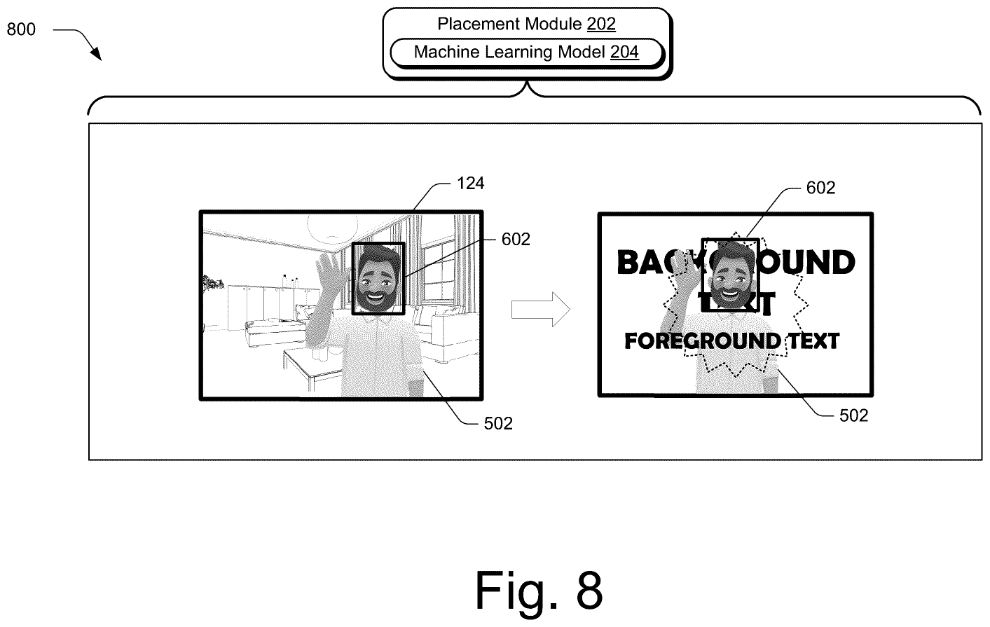

After receiving the template 122 and the digital video 124, the template module 116 uses a machine learning model to determine a location within the digital video 124 to place the animated content 126. The animated content 126, for instance, includes the layered text and the graphic of the outline of the sun. Because placement of the animated content depends on a location of a detected person in the digital video 124, the machine learning model first detects the person in the digital video. To determine a location for the layered text, the machine learning model isolates the detected person from a background and layers two levels of text layered behind the detected person in the digital video 124 and one level of text layered in front of the detected person in the digital video 124 as specified by the template. The machine learning model also determines a location to place the graphic of the outline of the sun based on the location of the detected person in the digital video 124 to overlay the detected person in the digital video 124, as specified by the template. In some examples, the machine learning model determines a location within the digital video 124 to place the animated content 126 that avoids obscuring or overlaying a face of the detected person, as described in further detail below with respect to FIG. 8.

After the template module 116 uses the machine learning model to determine the location within the digital video 124 to place the animated content 126, the template module 116 generates rendered animated content 118 by incorporating the animated content 126 within the digital video 124 at the location determined by the machine learning model. In this example, rendering the animated content includes removing a background from the digital video 124 and centering the detected person in a frame of the video. The template module 116 then generates an output 128 including the rendered animated content 118, further examples of which are described in the following sections and shown in corresponding figures.

In general, functionality, features, and concepts described in relation to the examples above and below are employed in the context of the example procedures described in this section. Further, functionality, features, and concepts described in relation to different figures and examples in this document are interchangeable among one another and are not limited to implementation in the context of a particular figure or procedure. Moreover, blocks associated with different representative procedures and corresponding figures herein are applicable together and/or combinable in different ways. Thus, individual functionality, features, and concepts described in relation to different example environments, devices, components, figures, and procedures herein are usable in any suitable combinations and are not limited to the particular combinations represented by the enumerated examples in this description.

### Template-Based Behaviors in Machine Learning

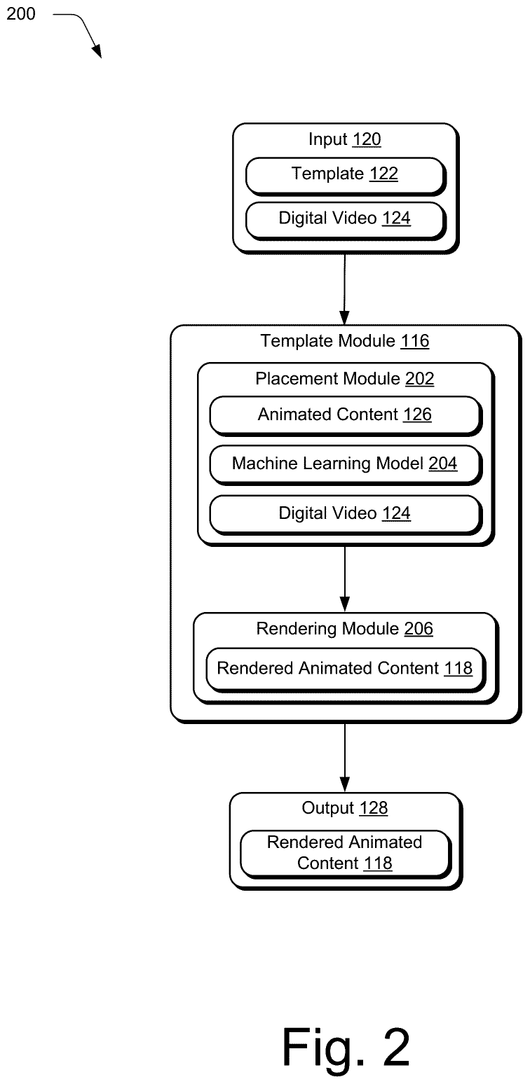

FIG. 2 depicts a system 200 in an example implementation showing operation of the template module 116 of FIG. 1 in greater detail. The following discussion describes techniques that are implementable utilizing the previously described systems and devices. Aspects of each of the procedures are implemented in hardware, firmware, software, or a combination thereof. The procedures are shown as a set of blocks that specify operations performed and/or caused by one or more devices and are not necessarily limited to the orders shown for performing the operations by the respective blocks. In portions of the following discussion, reference is made to FIGS. 1-14.

To begin in this example, a template module 116 receives an input 120 including a template 122 and a digital video 124. The template 122 includes data that specifies different types and styles of layouts that incorporate animated content 126 into the digital video 124. In some examples, the template 122 also includes data that specifies a behavior for the animated content 126 in the digital video 124. The behavior is a movement performed by the animated content 126 with respect to a portion of the digital video 124. For example, the template 122 specifies that a heart-shaped animation is attached to a detected face in the digital video 124 and has a behavior that follows the detected face as it moves in the digital video 124.

The template module 116 includes a placement module 202. The placement module 202 uses a machine learning model 204 to determine a location within a frame of the digital video to place the animated content. For example, the machine learning model 204 determines the location by analyzing the frame of the digital video and inferring an optimal location of the animated content 126 based on the data from the template 122 and detected features of the frame of the digital video 124. In some examples, the machine learning model 204 detects an object depicted in the frame of the digital video 124 to determine the location for placement of the animated content 126 in accordance with specifications of the data from the template 122. For example, the location for placement of the animated content 126 is a portion of the frame of the digital video 124 that includes a body part or face specified by the template 122.

The template module 116 also includes a rendering module 206. The rendering module 206 generates rendered animated content 118 by incorporating the animated content 126 within the frame of the digital video 124 at the location determined by the machine learning model 204. In some examples, the rendering module 206 detects a pose of the person detected in the frame of the digital video 124 and tracks the pose in additional frames to generate the rendered animated content 118. Additionally, in some examples the rendering module 206 auto-frames a face or other object specified by the template 122 in the frame of the digital video 124. The template module 116 then generates an output 128 including the rendered animated content 118 for display in the user interface.

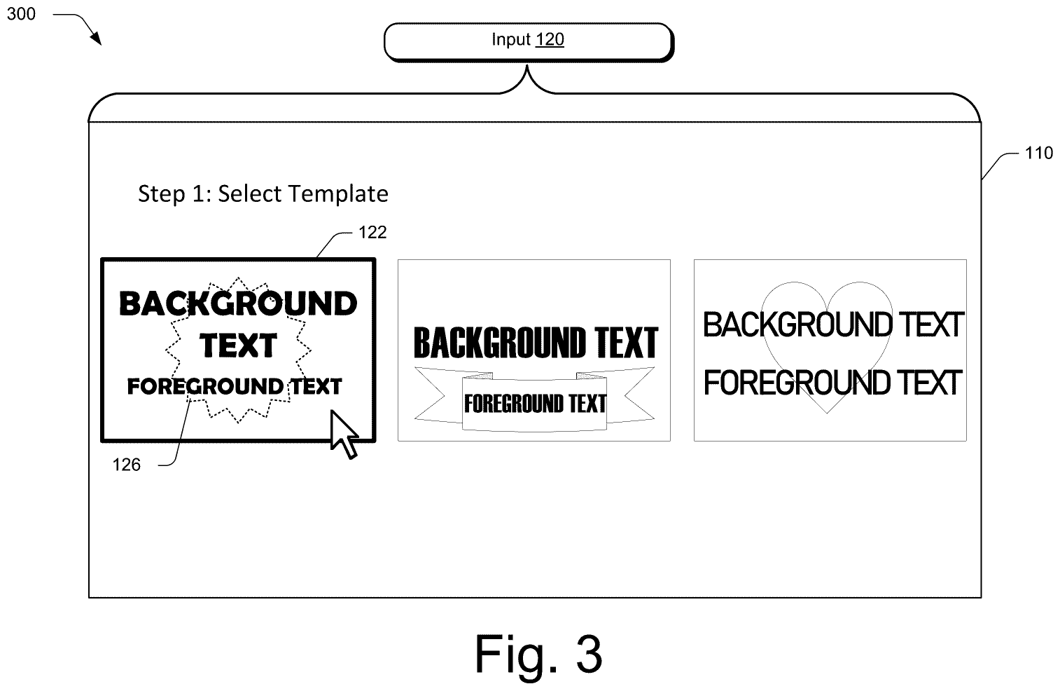

FIGS. 3-10 depict stages of template-based behaviors in machine learning. In some examples, the stages depicted in these figures are performed in a different order than described below.

FIG. 3 depicts an example 300 of receiving an input including a template selection. As illustrated, the template module 116 receives an input 120 including a user selection specifying a template 122. The template 122 includes data executable to generate animated content 126 for display relative to a specific portion of the digital video 124. For example, the template 122 specifies an arrangement for presentation of the animated content 126 with respect to the digital video 124 in a particular deign or style. In some examples, the template 122 is pre-authored and selected by the user or is authored by the user. For example, the template 122 is configured for manual generation or editing by a user using a software user interface or web interface using voice or text commands.

Animated content 126 includes, but is not limited to, images, GIFs, videos, text, stickers, emojis, memes, or other graphics for incorporation into the digital video 124. In some examples, the template 122 specifies a location for placement of the animated content 126 with respect to a specific portion of a digital video 124. For example, the template 122 specifies placement of animated content 126 above, below, to the right of, to the left of, in front of, behind, or in another relation to an object depicted in the digital video 124 or a region of the digital video 124. In other examples, a machine learning model infers a location for placement of the animated content 126 with respect to a specific portion of a digital video 124 based on a context of the animated content 126 and the digital video 124.

In some examples, the template 122 also specifies a behavior for the animated content 126. The behavior is a movement or other animation performed by the animated content 126 after incorporation into the digital video 124. Examples of behaviors include, but are not limited to, appearing, disappearing, fading, flying, floating, splitting, re-shaping, rotating, growing, shrinking, and moving in a direction. In some examples, the template 122 specifies a behavior for the animated content 126 with respect to a specific portion of a digital video 124. In some examples, the template 122 specifies prioritization of display for different discrete sets of boxes, depending on user preference, content of the digital video 124, timing of displayed texts with respect to an audio script, appearance, properties of displayed text regions, including foreground color, background color, text, font, weight, border, shadow, or other appearance attributes. In other examples, a machine learning model infers a behavior for the animated content 126 with respect to a specific portion of a digital video 124 based on a context of the animated content 126 and the digital video 124. In some examples, the template 122 specifies a time cue for beginning, ending, or performing another aspect of a behavior.

In this example, the template 122 includes data executable to generate animated content 126 for display relative to a detected person in a frame of the digital video 124. For example, the template 122 includes layered text and a graphic of an outline of a sun shape. The template 122 specifies two levels of text layered behind a detected person in the digital video 124 that recite “BACKGROUND TEXT” and one level of text layered in front of the detected person in the digital video 124 that recites “FOREGROUND TEXT.” In some examples, an additional user input is received to change placeholder text, seen here, to text desired by the user. The template 122 also specifies the graphic of the outline of the sun shape to overlay the detected person in the digital video 124.

In addition to including data executable to generate animated content 126, in some examples the template 122 specifies additional visual or audible elements for incorporation into the digital video 124. Examples of visual elements include, but are not limited to, backgrounds, labels, filters, textures, lighting, and other visual effects. Examples of audible elements include music, dialog, sound effects, or other aural elements.

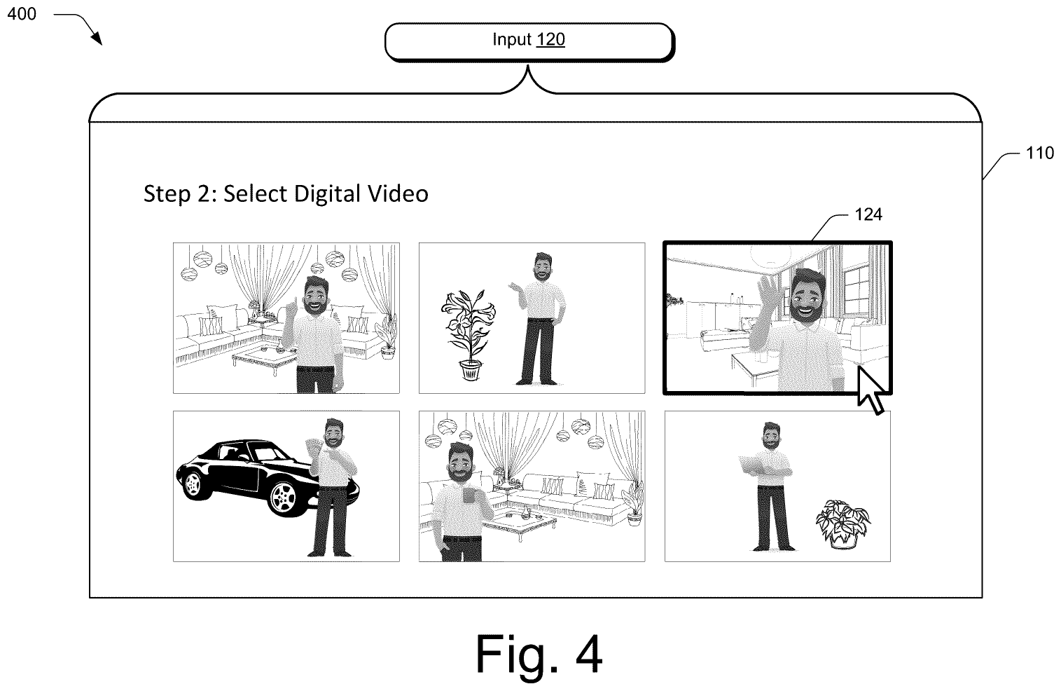

FIG. 4 depicts an example 400 of receiving an input including a digital video. As illustrated, the template module 116 receives an input 120 including a digital video 124.

In this example, the digital video 124 selected by a user from a user interface that includes multiple different videos. The digital video 124 here depicts a man that the user intends to use as a basis for incorporation of the animated content 126 specified by the template 122 into the digital video 124. In some examples, the digital video 124 is selected by importing the video from a storage location or by capturing a video using an image capture device. In some examples, the digital video 124 is a live video and the template-based behaviors in machine learning are generated in real-time.

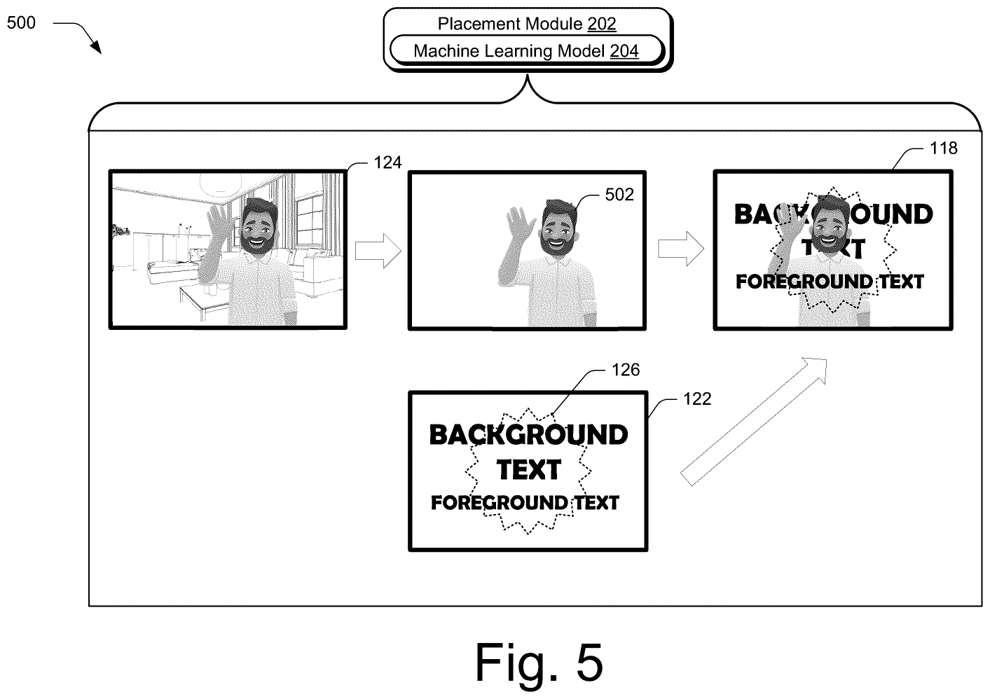

FIG. 5 depicts an example 500 of determining a location within a frame of the digital video to place animated content. FIG. 5 is a continuation of the example described in FIG. 3 and FIG. 4. After the template module 116 receives the template 122 and the digital video 124, the placement module 202 uses a machine learning model 204 to determine a location within a frame of the digital video 124 to place animated content 126 specified by the template.

To begin, the placement module 202 evaluates instructions included in the data executable to generate animated content 126 from the template 122. In some examples, the template 122 specifies locations for placement of animated content 126 relative to a detected person or object in the digital video 124. For example, the template 122 includes data executable to generate animated content 126 to appear behind, in front of, around, or in another relation to a detected person in the digital video 124. To determine the location specified by the template 122, the placement module 202 then uses the machine learning model 204 to detect the person or object in the digital video. For example, the machine learning model 204 implements a facial detection model or other image recognition model to detect the person or object. In some examples, the frame of the digital video 124 includes several persons or objects and the machine learning model 204 identifies a salient or prominent. In additional examples, the machine learning model 204 isolates the detected person or object from a remainder of the digital video 124 for incorporation into digital content specified by the template 122.

In this example, the template 122 includes data executable to generate animated content 126 for display relative to a detected person in a frame of the digital video 124. For example, the template 122 includes data to generate layered text and a graphic of an outline of a sun shape. The template 122 specifies two levels of text layered behind a detected person in the digital video 124 that recite “BACKGROUND TEXT” and one level of text layered in front of the detected person in the digital video 124 that recites “FOREGROUND TEXT.” Because the template includes instructions to incorporate the layered text and the graphic into specific locations with respect to the detected person, the placement module 202 first identifies the detected person 502 in the frame of the digital video 124. For example, the placement module 202 uses a machine learning model 204 that implements a facial detection model to identify the detected person 502. In this example, the machine learning model 204 also isolates the detected person 502 from the frame of the digital video 124 and removes a background from the frame of the digital video 124.

After the placement module 202 uses the machine learning model 204 to detect the person or object in the frame of the digital video 124, the placement module 202 uses the machine learning model 204 to determine a location relative to the detected person or object that is specified by the template 122. For example, the machine learning model 204 determines a location behind, in front of, around, or in another relation to the detected person or object in the digital video 124 as specified by the template 122. In some examples, the placement module 202 centers the detected person or object within the frame of the digital video before determining a location to place the animated content 126.

In this example, after identifying and isolating the detected person 502 in the frame of the digital video 124, the placement module 202 uses the machine learning model 204 to determine locations to place the layered text and the graphic that satisfy the instructions from the template 122. Because the template 122 specifies the two levels of text layered behind the detected person in the frame of the digital video 124 that recite “BACKGROUND TEXT” and the one level of text layered in front of the detected person in the frame of the digital video 124 that recites “FOREGROUND TEXT,” the machine learning model 204 determines a location behind the detected person 502 to place the background text and a location in front of the detected person 502 to place the foreground text. For example, the machine learning model 204 determines a location for the background text that is still readable behind the detected person. Additionally, the machine learning model 204 determines a location for the foreground text that does not cover up or obscure a salient or important portion of the detected person 502. For example, the foreground text does not cover a facial region of the detected person 502.

The machine learning model 204 is trained on data including multiple placements of animated content 126 into multiple digital videos. The machine learning model 204 leverages the data to determine the location within the frame of the digital video 124 to place the animated content 126 that satisfies the instructions included in the template 122, as illustrated. In some examples, the machine learning model 204 determines that following the placement instructions in the template 122 cause the animated content 126 to be obscured or to obscure a salient portion of the digital video 124 and instead determine a location that deviates from the instructions included in the template 122.

In other examples, the template 122 includes data executable to generate animated content 126 but not specific placement instructions. In these examples, the placement module 202 uses the machine learning model 204 to infer the location within the frame of the digital video 124 to place the animated content 126 based on training data including placement of animated content 126 in different digital videos.

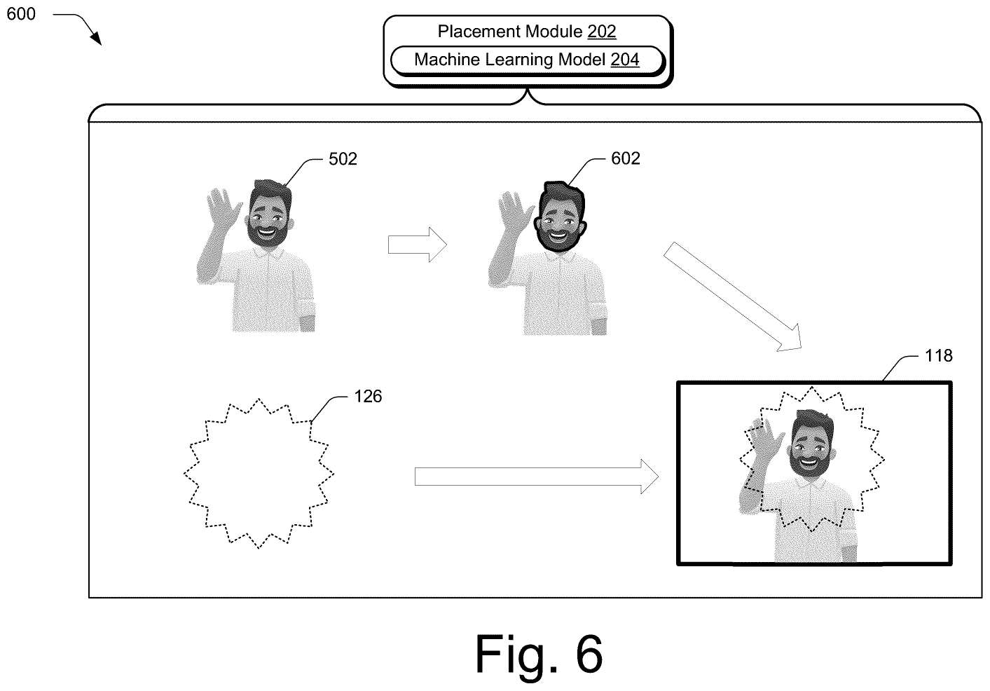

Additional examples of determining the location within the frame of the digital video in FIGS. 6-9.

FIG. 6 depicts an example 600 of determining the location within the frame of the digital video based on a location of an object detected in the frame of the digital video and attaching a portion of the animated content to the object detected in the frame of the digital video. FIG. 6 is a continuation of the example described in FIG. 5.

As discussed above with respect to FIG. 5, in some examples a template 122 assigns a location for incorporation of animated content 126 into a frame of a digital video 124. For example, the placement module 202 attaches animated content 126 as a digital “sticker” to a specific object depicted in the frame of the digital video 124. The animated content 126 is translated from its assigned location from one frame of the digital video 124 to the next frame. This means that as the animated content 126 appears to move with the digital object from frame to frame as the animated content 126 moves.

In this example, the template 122 includes data executable to generate animated content 126 that includes a graphic of an outline of a sun shape. The template 122 also includes instructions that specify the graphic is to attach to a face of a detected person 502 in the digital video 124.

To attach the graphic as specified in the template 122, the placement module 202 detects the detected person using the machine learning model 204 as described in relation to FIG. 5 above. Because the template 122 also includes instructions that specify the graphic is to attach to a face 602 of a detected person 502 in the digital video 124, the placement module 202 then uses the machine learning model 204 to identify the face 602 of the detected person 502 in the frame of the digital video 124. Alternatively, the machine learning model 204 uses a facial recognition model or other model trained to identify an object specified by the template 122.

After identifying the face 602 in the frame of the digital video 124, the placement module 202 determines the location within the frame of the digital video 124 to place the graphic of the outline of the sun shape, which is the animated content 126. For example, the template 122 includes instructions specifying the graphic of the outline of the sun shape is to be centered over the face 602 of the detected person 502. In response, the machine learning model 204 determines a location in the frame of the digital video 124 such that the outline of the sun shape is to be centered over the face 602. In this example, the machine learning model 204 is trained using a dataset including multiple instances of animated content attached to specific portions of objects in frames of digital video. This process is repeated for consecutive frames of the digital video 124 so that the animated content 126 appears to move with the digital object from frame to frame as the animated content 126 moves. In some examples, the machine learning model 204 changes a size or shape of the animated content 126 to satisfy instructions included in the template 122.

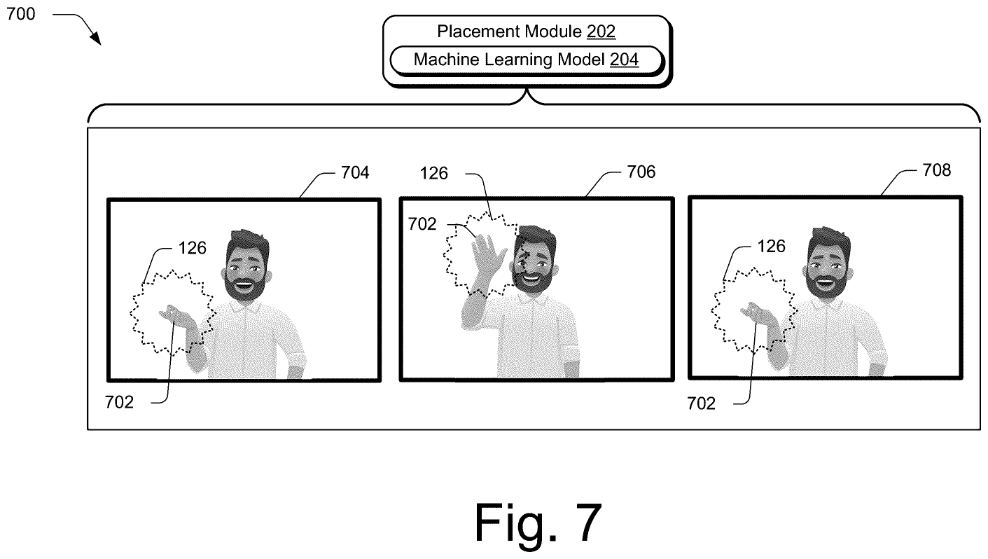

FIG. 7 depicts an example 700 of determining the location based on tracking a pose of a detected person depicted in the frame of the digital video. FIG. 7 is a continuation of the example described in FIG. 5.

As discussed above with respect to FIG. 5, in some examples a template 122 assigns a location for incorporation of animated content 126 into a frame of a digital video 124. For example, the placement module 202 attaches animated content 126 as a digital “sticker” to a designated object depicted in the frame of the digital video 124, including a body part. However, in some examples, the designated object moves positions in different frames of the digital video 124. In order to provide the appearance that the animated content 126 is attached to the designated object, the animated content 126 is translated from its designated location from one frame of the digital video 124 to the next frame. Therefore, the animated content 126 appears to move with the digital object from frame to frame as the animated content 126 moves.

In this example, the template 122 includes data executable to generate animated content 126 that includes a graphic of an outline of a sun shape. The template 122 also includes instructions that specify attachment of the graphic to a right hand 702 of a detected person 502 in the digital video 124. In other examples, the placement module 202 receives an additional user input to attach the animated content 126 to a specific portion of the digital video 124.

To attach the graphic as specified in the template 122, the placement module 202 detects the person using the machine learning model 204 as described in relation to FIG. 5 above. Because the template 122 also includes instructions that specify the graphic is to attach to the right hand 702 of a detected person 502 in the digital video 124, the placement module 202 then uses the machine learning model 204 to identify the right hand 702 of the detected person 502 in the frame of the digital video 124. Because the right hand 702 is moving in the digital video 124 and is in a different location in different frames, the machine learning model 204 repeats the process of identifying the right hand 702 in the frames of the digital video 124. For example, in frame one 704 the animated content 126 is attached to the right hand 702 in a low position. In frame two 706, the right hand 702 is raised, and the animated content 126 is attached to the right hand 702 in a raised position. In frame three 708, the right hand 702 is lowered again, and the animated content 126 is attached to the right hand 702 in a lowered position. For this reason, the animated content 126 appears to move with the digital object from frame to frame as the animated content 126 moves.

In other examples, the machine learning model 204 is trained to detect a pose of the detected person 502. For example, the template 122 includes instructions to trigger display of animated content 126 when the detected person 502 performs a specific pose. The machine learning model 204 then detects when the pose is performed by the detected person 502 and assigns a location to the designated portion of the digital video 124.

In some examples that contain fast-moving objects in the digital video 124, temporal stability is achieved using a combination of smooth filtering to detect faces, using temporal hysteresis for switching selected text regions, and using a dynamic-programming based algorithm that optimizes the best text regions per frame, considering text box transitions and associated overlaps with faces in frames of the digital video 124. For example, in live video, a layout rectangle for the template 122 is updated on a per-frame basis. Constant motion of a text box of the animated content 126 is undesirable for legibility reasons. Instead, a simple hysteresis enables switching away from the text box when its overlap with the face region exceeds a certain threshold, a number between 0 and 1 that indicates the fraction of the text box that is covered by the face region. Alternatively, maximum “velocity” or rate of change is be defined (to be under some noticeability threshold) and a target box is computed for each frame of the digital video 124, and the position of the text box is slowly moved toward that target box. Alternatively, an additional user input is received that indicates when to switch the layout boxes in real time via predefined triggers, including hand gestures or spoken keywords. This presents an “adaptation slider” which at one extreme selects a single text box location and size for the entire duration of the video (hysteresis=1), ensuring text always appears in a predictable location in the video regardless of content. At the other extreme, the text box updates to the optimal position every frame (hysteresis=0). In between, the hysteresis and maximum velocity thresholds are adjusted continuously so the user determines an amount of overlay to adapt to the detected person 502.

FIG. 8 depicts an example 800 of auto-framing a face depicted in the frame of the digital video. FIG. 8 is a continuation of the example described in FIG. 5.

In some examples, the placement module 202 uses the machine learning model 204 to auto-frame a face 602 depicted in the frame of the digital video 124 to determine a location within the frame of the digital video 124 to place animated content 126.

In this example, the template 122 includes data executable to generate animated content 126 that includes a graphic of an outline of a sun shape. The template 122 also includes instructions that specify the graphic is to attach to a face 602 of a detected person 502 in the digital video 124. To attach the graphic as specified in the template 122, the placement module 202 detects the detected person using the machine learning model 204 as described in relation to FIG. 5 above. Because the template 122 also includes instructions that specify the graphic is to attach to the face 602 of the detected person 502 in the digital video 124, the placement module 202 then uses the machine learning model 204 to identify the face 602 of the detected person 502 in the frame of the digital video 124 using a facial recognition or facial detection model. In some examples, the placement module 202 uses the machine learning model 204 to reposition the detected person 502 or the face 602 in the frame of the digital video 124 to satisfy specifications in the template 122. For example, the template 122 specifies that the face 602 of the detected person is centered in the frame of the digital video 124. In response, the placement module 202 centers the face 602 in the frame of the digital video 124.

In examples that include a single person in the digital video 124, the placement module 202 uses facial tracking to compute a face region, including a bounding box of a portion of the frame of the digital video 124 that is covered by the face 602. Then, the placement module 202 defines portions of the frame of the digital video 124 to the left, right, top, and bottom of the face region, abutting the boundaries of the frame of the digital video 124 and one side of the face 602. Specifically, each top/bottom/left/right region is computed as the largest region within the camera view that does not overlap with the bounding box. The placement module 202 then chooses the largest box to apply as a content box for the animated content 126 based on the largest region within the camera view that does not overlap with the bounding box. If the text of the animated content 126 is short and does not occupy the content box, a truncated content box is used and aligned with the center of the bounding box.

In some examples, the template module 116 receives an additional input selecting a discrete preset. For example, the template 122 includes different possible locations for animated content 126 or content boxes that are selected by the user. A text box is then selected from its variants by finding a text box that has the largest overlap with a candidate box, resulting in minimal overlap between the face 602 and the text.

Some examples include aligning text of the animated content 126 vertically at a height of the face 602. To achieve this, the placement module 202 optimizes the text within the text box so that the text is shifted to a height of the face 602.

In other examples, the placement module 202 filters input face regions. A list of “potential grids” are constructed dynamically rather than switching between pre-defined grid styles that exclude potential grid cells. For example, consider a wide video (e.g., 1280×320), in which the detected person 502 is to the left of the screen. An ideal position for the text to appear “balanced” is the center cell of the frame of the digital video 124. Existing grid styles do not include the center cell. This is modeled as a graph using a shortest path problem, using G=(V, E) where V (vertices) represent the grid cells for each word. In an example where a segment has 10 words, then (V)=10× 9=90. E (edges) are the cost of transitioning from one word to the next word by moving from one grid cell to another. The edge cost=temporal cost T+spatial cost S. T=distance between the grid cells chosen between adjacent words. S=the amount of overlap between the tracked face region and the corresponding grid cell. To find the shortest path from word 0 to word N (where N=total number of words), a list of spatial-temporal coherent text box is constructed for rendering.

In some examples, the placement module 202 determines multiple locations to split up animated content 126. For example, the animated content 126 includes a large amount of text, but there is no singular area of negative space available in the frame of the digital video 124 to position the animated content 126. In response, the placement module 202 divides the animated content 126 into sections of animated content and determines multiple locations in the frame of the digital video 124 to position the sections of animate content.

Some examples involve multiple detected persons in the digital video 124. Based on this, the placement module 202 determines which detected person of the multiple detected persons is speaking and then determines a location to position the animated content 126 around the person speaking. In an example including a change from one person speaking to a different person speaking, the placement module 202 tracks speakers to determine a position for the animated content 126.

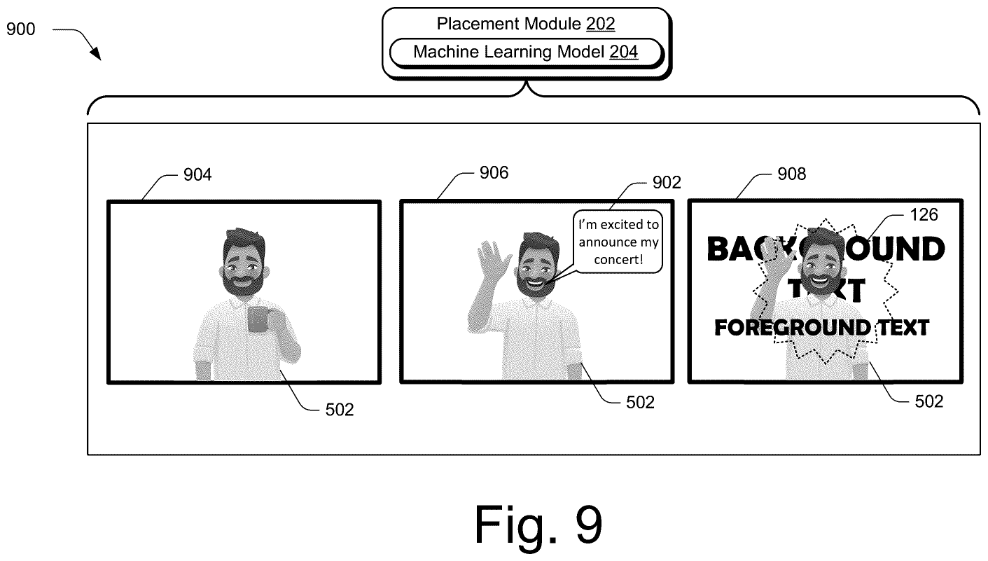

FIG. 9 depicts an example 900 of detecting audio of the digital video. FIG. 9 is a continuation of the example described in FIG. 5.

Some examples include a template 122 that specifies display of animated content 126 in response to detected audio or detected speech in the digital video 124. For example, the template 122 includes data executable to generate animated content 126 when triggered by the occurrence of a detected sound or detected speech.

In this example, the template 122 includes instructions for animated content 126 to be displayed when the placement module 202 detects speech 902 in the digital video 124. For instance, scene one 904 of the digital video 124 does not feature speech. Because the placement module 202 does not yet detect speech, the placement module 202 does not yet determine a location in the digital video 124 for the animated content 126. Later, the placement module 202 detects speech 902 in scene two 906. For instance, the detected person 502 says “I'm excited to announce my concert!” In response to detecting the speech 902, the placement module 202 determines a location in the digital video 124 for the animated content 126 in scene three 908. In some examples, the template 122 includes instructions for the placement module 202 to the use the machine learning model 204 to convert detected speech into text for incorporation into the animated content 126. For example, the placement module 202 takes as input an audio track or script.

Other examples include a template 122 that specifies a modified behavior for the animated content 126 in response to detected audio or detected speech in the digital video 124. For example, a speed of detected speech modifies a speed of presentation of animated content 126. Other aspects of detected audio that modify behavior of animated content 126 include tone, emotion, and specified words.

In other examples, the animated content 126 is determined by detected speech. For example, a person depicted in the digital video 124 tells a story including multiple elements. In response, the placement module 202 uses the machine learning model 204 to identify visual elements to incorporate into the animated content 126 at illustrate elements of the story.

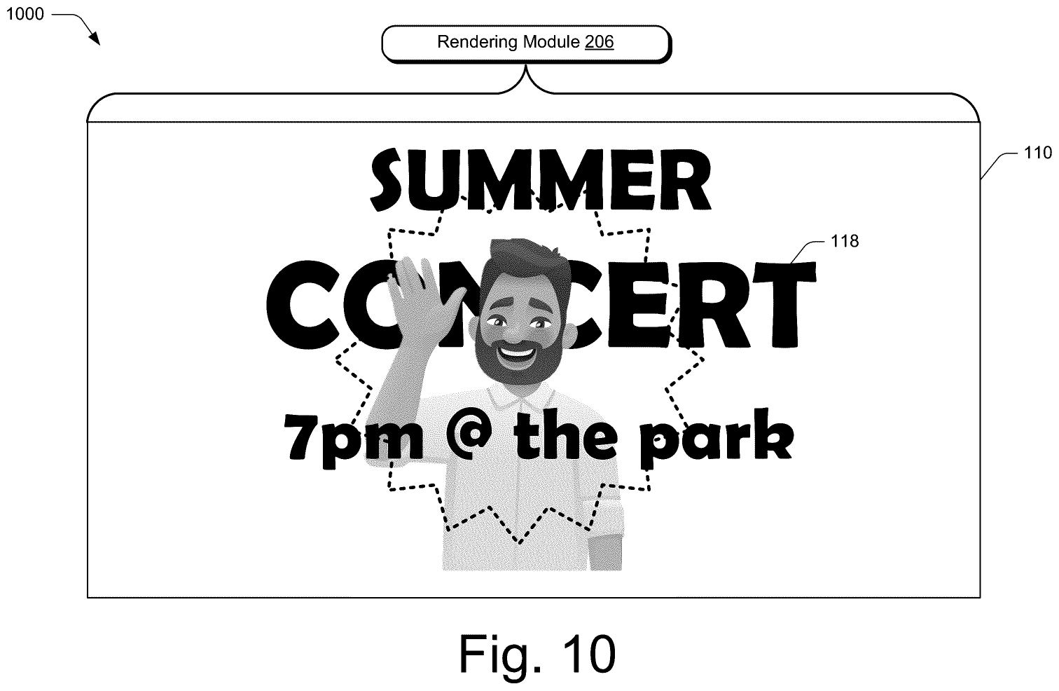

FIG. 10 depicts an example 1000 of rendering the animated content within the frame of the digital video at the location determined by the machine learning model. FIG. 10 is a continuation of the example described in FIG. 5.

After the placement module 202 determines a location within a frame of the digital video 124 to place the animated content 126, the rendering module 206 generates rendered animated content 118 by incorporating the animated content 126 within the frame of the digital video 124 at the location determined by the machine learning model 204. In some examples, the rendered animated content 118 is available for download to a storage device.

In some examples, the template 122 specifies a portion of the animated content 126 that is configurable by a user. In this example, the user updates the text of the animated content 126 to recite “SUMMER CONCERT 7 pm @ the park.” Other configurations of the animated content 126 that are available for customization include backgrounds, fonts, colors, sizing, filters, music, and other audio or visual effects.

### Example Procedures

The following discussion describes techniques which are implementable utilizing the previously described systems and devices. Aspects of each of the procedures are implementable in hardware, firmware, software, or a combination thereof. The procedures are shown as a set of blocks that specify operations performed by one or more devices and are not necessarily limited to the orders shown for performing the operations by the respective blocks. In portions of the following discussion, reference is made to FIGS. 1-10.

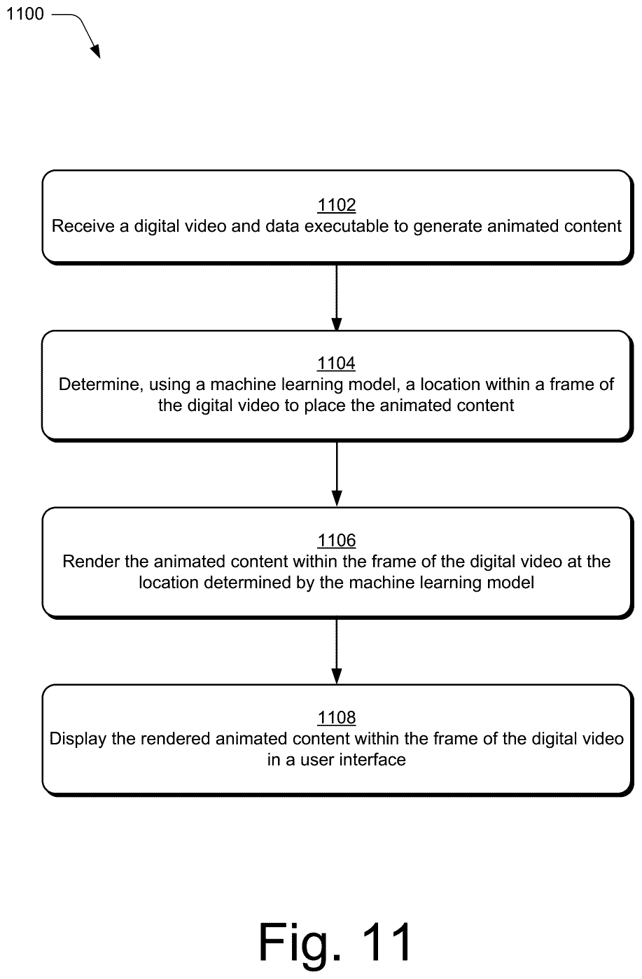

FIG. 11 depicts a procedure 1100 in an example implementation of template-based behaviors in machine learning. At block 1102 a digital video 124 and data executable to generate animated content 126 are received. In some examples, the animated content 126 comprises a behavior including a specified movement for a portion of the animated content 126 selected by a user.

At block 1104, a location within a frame of the digital video 124 to place the animated content 126 is determined using a machine learning model 204. In some examples, the machine learning model 204 determines the location based on a location of an object detected in the frame of the digital video 124. Additionally or alternatively, the machine learning model 204 determines the location based on tracking a pose of a detected person 502 depicted in the frame of the digital video 124. In some examples, wherein a portion of the animated content 126 is layered behind or in front of an object depicted in the frame of the digital video 124. In other examples, the location is based on detected audio of the digital video 124.

At block 1106, the animated content 126 is rendered within the frame of the digital video 124 at the location determined by the machine learning model 204. In some examples, rendering the animated content 126 involves attaching a portion of the animated content to the object detected in the frame of the digital video 124. Additionally or alternatively, rendering the animated content 126 further comprises auto-framing a face depicted in the frame of the digital video 124. In some examples, a behavior of the animated content 126 is triggered by a word or phrase detected in audio of the digital video 124.

At block 1108, the rendered animated content 118 is displayed within the frame of the digital video 124 in a user interface 110.

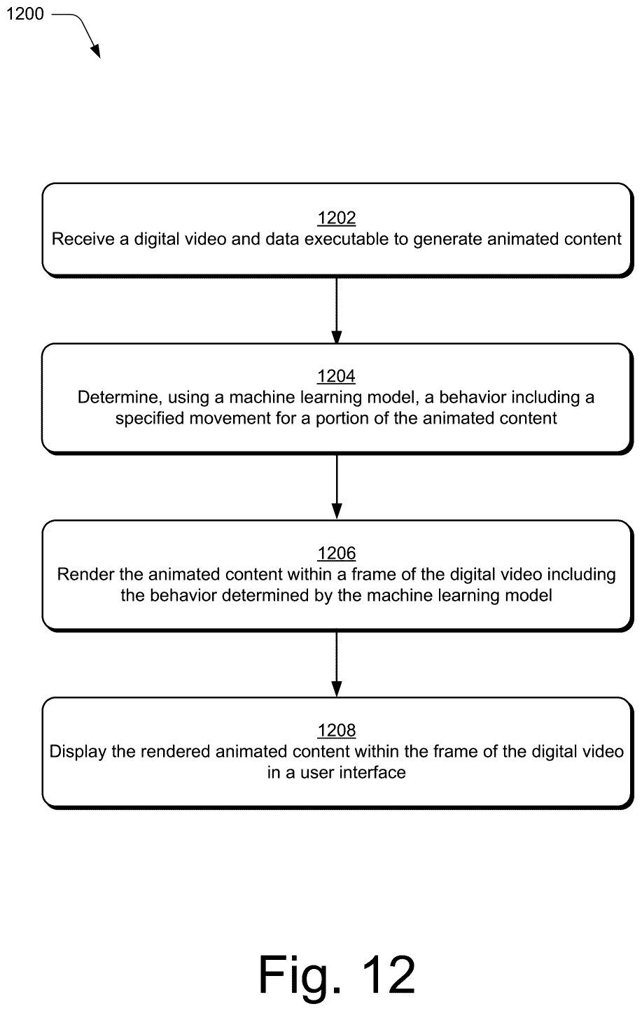

FIG. 12 depicts a procedure 1200 in an additional example implementation of template-based behaviors in machine learning. At block 1202, a digital video 124 and data executable to generate animated content 126 is received.

At block 1204, a behavior including a specified movement for a portion of the animated content 126 is determined using a machine learning model 204. In some examples, determining the behavior is based on detected speech in the digital video 124. In other examples, the machine learning model determines the behavior based on a location of an object detected in the frame of the digital video 124. Additionally or alternatively, the machine learning model 204 determines the behavior based on tracking a pose of a detected person depicted in the frame of the digital video 124. In some examples, the machine learning model determines the behavior based on audio of the digital video 124.

At block 1206, the animated content 126 is rendered within a frame of the digital video 124 including the behavior determined by the machine learning model 204.

At block 1208, the rendered animated content 118 is displayed within the frame of the digital video 124 in a user interface 110. Some examples further comprise converting the detected speech into text for incorporation into the animated content 126. Additionally or alternatively, rendering the animated content 126 further comprises removing a background from the frame of the digital video 124.

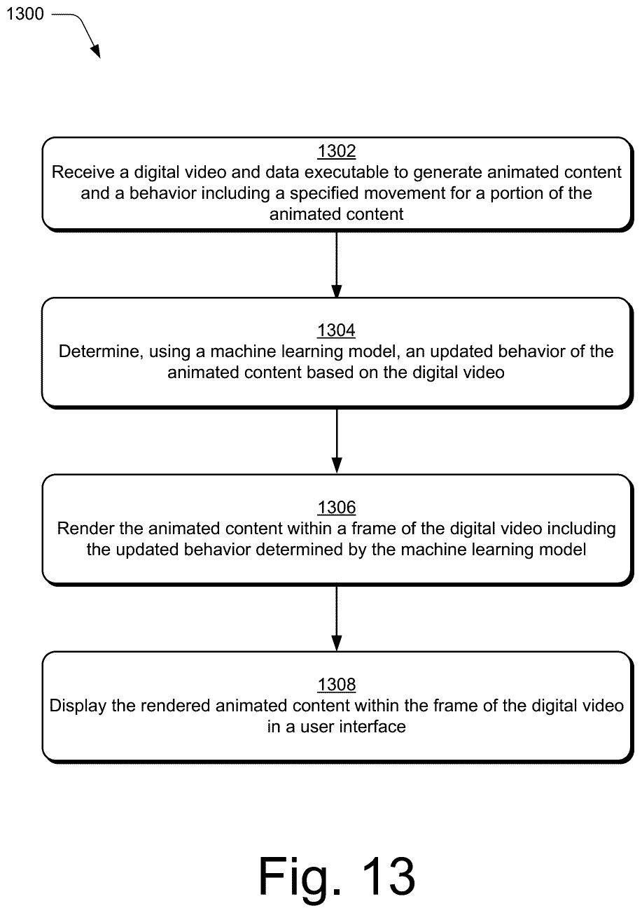

FIG. 13 depicts a procedure 1300 in an additional example implementation of template-based behaviors in machine learning. At block 1302, a digital video 124 and data executable to generate animated content 126 and a behavior including a specified movement for a portion of the animated content 126 are received.

At block 1304, an updated behavior of the animated content 126 is determined using a machine learning model 204 based on the digital video 124. In some examples, the machine learning model 204 determines the updated behavior based on a location of an object detected in the frame of the digital video 124. Additionally or alternatively, the machine learning model 204 determines the updated behavior based on tracking a pose of a detected person depicted in the frame of the digital video 124. In other examples, the machine learning model 204 determines the updated behavior based on audio of the digital video 124.

At block 1306, the animated content 126 is rendered within a frame of the digital video 124 including the updated behavior determined by the machine learning model 204.

At block 1308, the rendered animated content 118 is displayed within the frame of the digital video 124 in a user interface 110.

### Example System and Device

FIG. 14 illustrates an example system generally at 1400 that includes an example computing device 1402 that is representative of one or more computing systems and/or devices that implement the various techniques described herein. This is illustrated through inclusion of the template module 116. The computing device 1402 is configurable, for example, as a server of a service provider, a device associated with a client (e.g., a client device), an on-chip system, and/or any other suitable computing device or computing system.

The example computing device 1402 as illustrated includes a processing system 1404, one or more computer-readable media 1406, and one or more I/O interface 1408 that are communicatively coupled, one to another. Although not shown, the computing device 1402 further includes a system bus or other data and command transfer system that couples the various components, one to another. A system bus includes any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 1404 is representative of functionality to perform one or more operations using hardware. Accordingly, the processing system 1404 is illustrated as including hardware element 1410 that is configurable as processors, functional blocks, and so forth. This includes implementation in hardware as an application specific integrated circuit or other logic device formed using one or more semiconductors. The hardware elements 1410 are not limited by the materials from which they are formed or the processing mechanisms employed therein. For example, processors are configurable as semiconductor(s) and/or transistors (e.g., electronic integrated circuits (ICs)). In such a context, processor-executable instructions are electronically-executable instructions.

The computer-readable storage media 1406 is illustrated as including memory/storage 1412. The memory/storage 1412 represents memory/storage capacity associated with one or more computer-readable media. The memory/storage 1412 includes volatile media (such as random access memory (RAM)) and/or nonvolatile media (such as read only memory (ROM), Flash memory, optical disks, magnetic disks, and so forth). The memory/storage 1412 includes fixed media (e.g., RAM, ROM, a fixed hard drive, and so on) as well as removable media (e.g., Flash memory, a removable hard drive, an optical disc, and so forth). The computer-readable media 1406 is configurable in a variety of other ways as further described below.

Input/output interface(s) 1408 are representative of functionality to allow a user to enter commands and information to computing device 1402, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., employing visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 1402 is configurable in a variety of ways as further described below to support user interaction.

Various techniques are described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques are configurable on a variety of commercial computing platforms having a variety of processors.

An implementation of the described modules and techniques is stored on or transmitted across some form of computer-readable media. The computer-readable media includes a variety of media that is accessed by the computing device 1402. By way of example, and not limitation, computer-readable media includes “computer-readable storage media” and “computer-readable signal media.”

“Computer-readable storage media” refers to media and/or devices that enable persistent and/or non-transitory storage of information in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media include but are not limited to RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and are accessible by a computer.

“Computer-readable signal media” refers to a signal-bearing medium that is configured to transmit instructions to the hardware of the computing device 1402, such as via a network. Signal media typically embodies computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 1410 and computer-readable media 1406 are representative of modules, programmable device logic and/or fixed device logic implemented in a hardware form that are employed in some embodiments to implement at least some aspects of the techniques described herein, such as to perform one or more instructions. Hardware includes components of an integrated circuit or on-chip system, an application-specific integrated circuit (ASIC), a field-programmable gate array (FPGA), a complex programmable logic device (CPLD), and other implementations in silicon or other hardware. In this context, hardware operates as a processing device that performs program tasks defined by instructions and/or logic embodied by the hardware as well as a hardware utilized to store instructions for execution, e.g., the computer-readable storage media described previously.

Combinations of the foregoing are also be employed to implement various techniques described herein. Accordingly, software, hardware, or executable modules are implemented as one or more instructions and/or logic embodied on some form of computer-readable storage media and/or by one or more hardware elements 1410. The computing device 1402 is configured to implement particular instructions and/or functions corresponding to the software and/or hardware modules. Accordingly, implementation of a module that is executable by the computing device 1402 as software is achieved at least partially in hardware, e.g., through use of computer-readable storage media and/or hardware elements 1410 of the processing system 1404. The instructions and/or functions are executable/operable by one or more articles of manufacture (for example, one or more computing devices and/or processing systems 1404) to implement techniques, modules, and examples described herein.

The techniques described herein are supported by various configurations of the computing device 1402 and are not limited to the specific examples of the techniques described herein. This functionality is also implementable through use of a distributed system, such as over a “cloud” 1114 via a platform 1416 as described below.

The cloud 1414 includes and/or is representative of a platform 1416 for resources 1418. The platform 1416 abstracts underlying functionality of hardware (e.g., servers) and software resources of the cloud 1414. The resources 1418 include applications and/or data that can be utilized when computer processing is executed on servers that are remote from the computing device 1402. Resources 1418 can also include services provided over the Internet and/or through a subscriber network, such as a cellular or Wi-Fi network.

The platform 1416 abstracts resources and functions to connect the computing device 1402 with other computing devices. The platform 1416 also serves to abstract scaling of resources to provide a corresponding level of scale to encountered demand for the resources 1418 that are implemented via the platform 1416. Accordingly, in an interconnected device embodiment, implementation of functionality described herein is distributable throughout the system 1400. For example, the functionality is implementable in part on the computing device 1402 as well as via the platform 1416 that abstracts the functionality of the cloud 1414.

What is claimed is:

1. A method comprising:
receiving, by a processing device, a digital video and data executable to generate animated content;
determining, by the processing device using a machine learning model, a location within a frame of the digital video to place the animated content;
rendering, by the processing device, the animated content within the frame of the digital video at the location determined by the machine learning model; and
displaying, by the processing device, the rendered animated content within the frame of the digital video in a user interface.

2. The method of claim 1, wherein the machine learning model determines the location based on a location of an object detected in the frame of the digital video.

3. The method of claim 2, wherein rendering the animated content involves attaching a portion of the animated content to the object detected in the frame of the digital video.

4. The method of claim 1, wherein the machine learning model determines the location based on tracking a pose of a detected person depicted in frame of the digital video.

5. The method of claim 1, wherein rendering the animated content further comprises auto-framing a face depicted in the frame of the digital video.

6. The method of claim 1, wherein a portion of the animated content is layered behind or in front of an object depicted in the frame of the digital video.

7. The method of claim 1, wherein the location is based on detected audio of the digital video.

8. The method of claim 1, wherein a behavior of the animated content is triggered by a word or phrase detected in audio of the digital video.

9. The method of claim 1, wherein the animated content comprises a behavior including a specified movement for a portion of the animated content selected by a user.

10. A system comprising:
a memory component; and
a processing device coupled to the memory component, the processing device to perform operations comprising:
receiving a digital video and data executable to generate animated content;
determining, using a machine learning model, a behavior including a specified movement for a portion of the animated content;
rendering the animated content within a frame of the digital video including the behavior determined by the machine learning model; and
displaying the rendered animated content within the frame of the digital video in a user interface.

11. The system of claim 10, wherein determining the behavior is based on detected speech in the digital video.

12. The system of claim 11, further comprising converting the detected speech into text for incorporation into the animated content.

13. The system of claim 10, wherein rendering the animated content further comprises removing a background from the frame of the digital video.

14. The system of claim 10, wherein the machine learning model determines the behavior based on a location of an object detected in the frame of the digital video.

15. The system of claim 10, wherein the machine learning model determines the behavior based on tracking a pose of a detected person depicted in the frame of the digital video.

16. The system of claim 10, wherein the machine learning model determines the behavior based on audio of the digital video.

17. A non-transitory computer-readable storage medium storing executable instructions, which when executed by a processing device, cause the processing device to perform operations comprising:
receiving a digital video and data executable to generate animated content and a behavior including a specified movement for a portion of the animated content;
determining, using a machine learning model, an updated behavior of the animated content based on the digital video;
rendering the animated content within a frame of the digital video including the updated behavior determined by the machine learning model; and
displaying the rendered animated content within the frame of the digital video in a user interface.

18. The non-transitory computer-readable storage medium of claim 17, wherein the machine learning model determines the updated behavior based on a location of an object detected in the frame of the digital video.

19. The non-transitory computer-readable storage medium of claim 17, wherein the machine learning model determines the updated behavior based on tracking a pose of a detected person depicted in the frame of the digital video.

20. The non-transitory computer-readable storage medium of claim 17,
wherein the machine learning model determines the updated behavior based on audio of the digital video.
